(19) United States
(12) Patent Application Publication
(10) Pub. No.: US 2017/0091723 A1
(43) Pub. Date: Mar. 30, 2017

(54) DEVICE FOR CONTROLLING DATA CARRIED BY AN ITEM OF ON-BOARD EQUIPMENT, ASSOCIATED FEE COLLECTION SYSTEM AND METHOD

(71) Applicant: THALES, COURBEVOIE (FR)

(72) Inventor: Pascal BRAS, BRETIGNY (FR)

(21) Appl. No.: 15/311,438

(22) PCT Filed: May 15, 2015
(86) PCT No.: PCT/EP2015/060780

§ 371 Date: Nov. 15, 2016

(30) Foreign Application Priority Data
May 16, 2014 (FR) 14 01114

(51) Int. Cl. G06Q 20/10; G06F 9/445; H04L 29/08; G06F 11/07

(52) U.S. Cl. CPC G06Q 20/10; G06F 11/0739; G06F 11/0751; G06F 11/0772; G06F 11/0793; G06F 8/65; H04L 67/34

(57) ABSTRACT

This control device comprises a first mobile terminal and a second terminal, said terminals being separate from one another and suitable for communicating with one another by wireless communication means. The first terminal incorporates a wireless communication system for reading data carried by an item of equipment, onboard a vehicle, of a fee collection system. The second terminal includes a main computer for interpreting the read data, and a viewer for displaying the interpreted data. The first terminal is suitable for transferring the read data to the second terminal via the wireless communication means.

The present invention relates to a control device for controlling data carried by an item of equipment, onboard a vehicle, of a fee collection system, the control device comprising a wireless communication system to read data carried by the onboard equipment, a main computer for interpreting the read data, and a viewer to display the interpreted data.

The invention also relates to a fee collection system comprising such a control device, and a method for controlling data carried by an item of equipment, onboard a vehicle, of a fee collection system.

It is common practice for users of a road network to be subject to a fee to use that road. This fee is generally intended to cover the construction and upkeep costs for the road network. Exceptionally, it may be intended to cover other costs incurred for the travel of vehicles on the road network, such as environmental damage caused by that travel. The fee to which the user is subject generally depends on the class of vehicles to which the vehicle he is driving belongs.

This fee is collected using a so-called toll system. This system most often comprises toll gates at the entrance and exit of the road network, in order to detect the entry of a vehicle onto the road network and its departure from the road network. Operators check users when they leave the road network, and ask them to pay a fee, the amount of which depends on their point of entry on the network and the class of vehicle they are driving.

With a view to automating the fee withdrawal system, vehicles in some vehicle classes have been equipped with onboard items of equipment to withdraw the fee. These onboard items of equipment are equipped with a geolocation system making it possible to determine the number of kilometers traveled by the vehicle on the road network to which the fee applies. These onboard items of equipment also store information on the vehicle making it possible to determine the vehicle class to which this vehicle belongs. The information relative to the vehicle and its travel on the road network is used to calculate the amount of the fee due by the user. It is thus possible to do away with the installation of toll gates at the entrances to and exits from the road network.

However, the risks of fraud are considerable, the user being able to remove the onboard item of equipment from his vehicle, or alter the information relative to the vehicle registered in the onboard item of equipment. In order to avoid these risks of fraud, automatic toll systems of the aforementioned type are equipped with an anti-fraud system. This anti-fraud system generally comprises gates and automatic inspection terminals, distributed along the road network and suitable for comparing the data relative to the vehicle stored in the onboard item of equipment with the actual data relative to the vehicle. This anti-fraud system also most often comprises manual and onboard control devices, suitable for allowing the inspection of vehicles by operators on foot or in cars.

These manual control devices typically comprise, in a same unit, a wireless communication system to read the data carried by the onboard item of equipment, a main computer to interpret the read data, and a viewer to display the interpreted data.

These control devices have the drawback of being heavy and cumbersome, making their use tedious for operators and inconvenient in case of exceptional situations, such as in case of attack or pursuit of a violator. They are also not very upgradable.

Furthermore, operators using both manual control devices and onboard control devices are required to adapt to the interfaces of two different devices, and must manage data relative to their inspections in two different databases.

One aim of the invention is to facilitate the manipulation of manual control devices by operators. Another aim is to make these manual control devices more upgradable. An additional aim is to simplify the interface between the operator and the different control devices that he uses.

To that end, the invention relates to a control device of the aforementioned type, characterized in that it comprises a first mobile terminal and a second terminal, said terminals being separate from one another and suitable for communicating with one another by wireless communication means, the first terminal incorporating the wireless communication system and the second terminal including the main computer and the viewer, the first terminal being suitable for transferring the read data to the second terminal via the wireless communication means.

According to specific embodiments of the invention, the control device also has one or more of the following features, considered alone or according to any technically possible combination(s):
the first terminal comprises a secondary computer programmed to perform preprocessing of the read data and a device for presenting synthetic information to a user of the first terminal based on a result of the preprocessing of the read data;
the preprocessing of the read data comprises searching for a signal of a malfunction of the onboard equipment in the read data, and the presentation device is suitable for occupying a state corresponding to the identification, by the secondary computer, of a signal of a malfunction of the onboard equipment in the read data;
the preprocessing of the read data comprises comparing an identifier of the onboard item of equipment with a list of identifiers stored in a memory of the first terminal, and the presentation device is suitable for occupying a state corresponding to the identification, by the secondary computer, of the presence of the identifier of the onboard item of equipment in the list;
the presentation device is suitable for occupying a state corresponding to the lack of identification, by the secondary computer, of a signal of a malfunction of the onboard item of equipment in the read data or of the presence of the identifier of the onboard item of equipment in the list;
the second terminal comprises a module for connecting to a remote server and the secondary computer is programmed to download updates from said remote server, via the second terminal, and to install said updates;
the wireless communication system is a dedicated short-range communication system, and the wireless communication means comprise a Bluetooth or Wi-Fi communication system;
the first terminal comprises a member, able to be actuated by a user, for initiating the reading of data by the wireless communication system; and
the first terminal comprises its own battery.

The invention also relates to a fee collection system comprising an onboard item of equipment of a vehicle and a control device as defined above to control the data carried by said onboard item of equipment.

According to one particular embodiment of the invention, the fee collection system also has the following feature:
said fee collection system comprises a terminal onboard a vehicle, said onboard terminal including a wireless communication system to read the data carried by the onboard item of equipment, and means for communicating with the second terminal to transfer the read data to the second terminal, the main computer being programmed to interpret the data read by the onboard terminal, and the viewer being suitable for displaying this data after it has been interpreted.

The invention also relates to a method for controlling data carried by an item of equipment, onboard a vehicle, of a fee collection system, comprising the following steps:
remote reading, by a first mobile terminal, of data carried by the onboard item of equipment,
transfer of the read data aerially, from the first terminal to a second terminal,
interpretation of the transferred data by a computer of the second terminal, and
display of the interpreted data by a viewer of the second terminal.

According to specific embodiments of the invention, the method also has one or more of the following features, considered alone or according to any technically possible combination(s):
said control method comprises a step for preprocessing, by the first terminal, of the read data, and a step for presentation, by the first terminal, of synthetic information to a user of the first terminal based on a result of the preprocessing of the read data;
the preprocessing step comprises a sub-step for looking for a signal of a malfunction of the onboard item of equipment in the read data and/or a sub-step for comparing an identifier of the onboard item of equipment with a list of identifiers stored in a memory of the first terminal; and
said control method comprises a step for initiating the reading of the data by actuation of a member of the first terminal by a user.

Other features and advantages of the invention will appear upon reading the following description, provided solely as an example and done in reference to the appended drawings, in which:

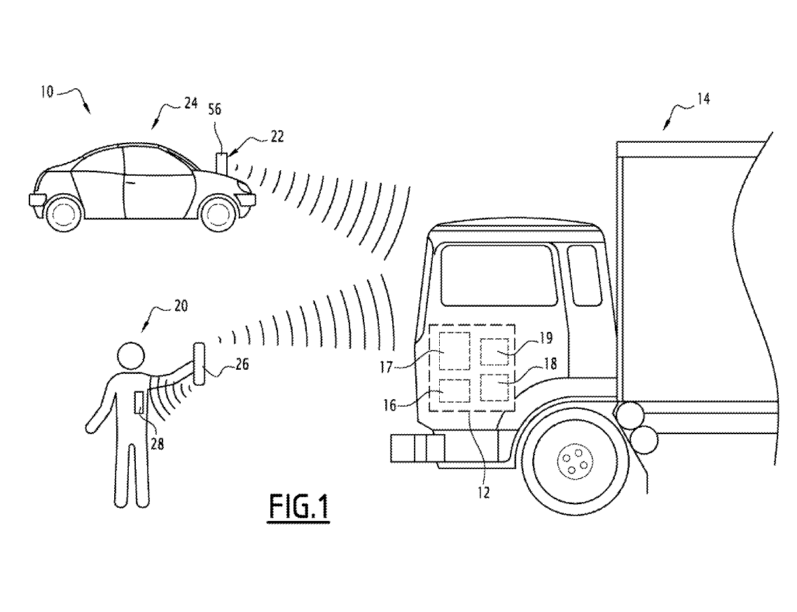

FIG. 1 is a diagrammatic view of part of a fee collection system according to the invention,

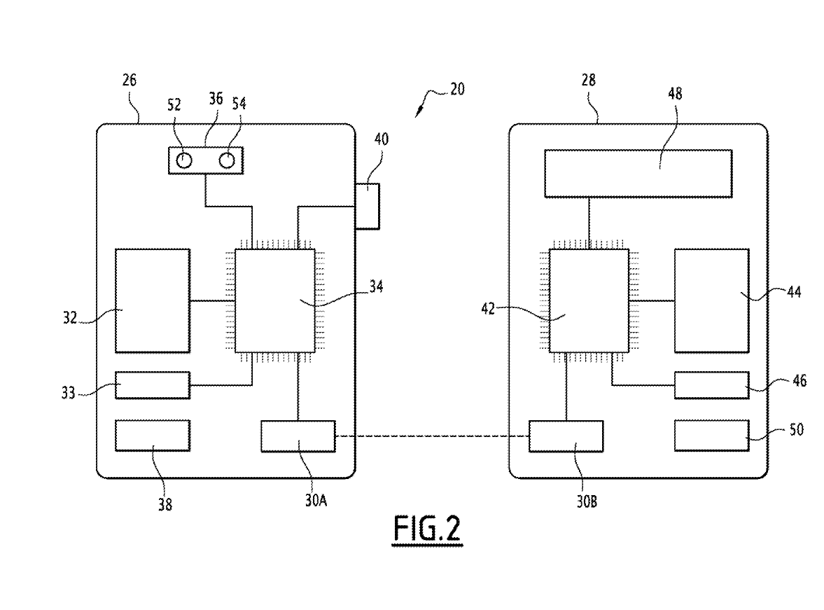

FIG. 2 is a diagrammatic view of a manual control device of the collection system of FIG. 1, and

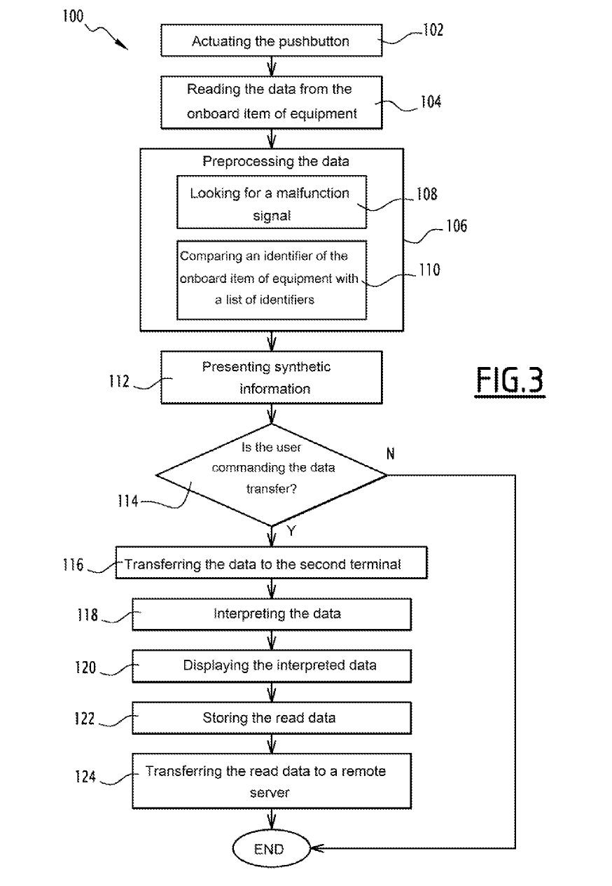

FIG. 3 is a diagram illustrating a control method carried out using the collection system of FIG. 1.

The fee collection system 10, shown in FIG. 1, is intended to collect a fee for the use of a road network by users of that network.

This collection system 10 comprises an item of equipment 12 onboard a vehicle 14, for example a truck. In a known manner, this onboard item of equipment 12 comprises a memory 16 storing an identifier of the onboard item of equipment 12 and information relative to the vehicle 14, for example its length, its number of axles, its gross vehicle weight rating (GVWR), its authorized gross vehicle weight (AGWV), and its emissions class based on the relevant European standards. It also comprises a wireless communication system 17, for transmitting information relative to the vehicle 14 to control systems for that information. Preferably, it further comprises a geolocation module 18, generating geolocation data of the vehicle 14, and a system 19 for transmitting geolocation data and information relative to the vehicle 14 to a computing unit (not shown) for a fee amount due by the user of the vehicle 14.

The communication system 17 is preferably a dedicated short-range communication (DSRC) system, the communication protocol for which is compliant with standards ISO 14906, EN 15509 and ISO 12813. The transmission system 19 is preferably a data transmission network via mobile telephone network.

The fee collection system 10 also comprises control systems for information relative to the vehicle 14 stored in the memory 16. These control systems in particular comprise a manual control device 20. They also comprise a control device 22 onboard a control vehicle 24. Preferably, they also comprise gates and automatic control terminals (not shown) distributed along the road network.

The manual control device 20 is suitable for being manipulated by an operator on foot to control the onboard items of equipment 12 onboard vehicles 14, in particular when these vehicles 14 are stopped, for example in the parking lot of a rest area.

In reference to FIG. 2, the manual control device 20 according to the invention comprises two terminals 26, 28. A first 26 of said terminals 26, 28 is a mobile terminal, i.e., suitable for being carried by hand by the operator; to that end, its weight is less than 250 grams. The second terminal 28 is preferably a smartphone; alternatively, the second terminal 28 is a tablet, a laptop computer, or a computer onboard the control vehicle 24.

The first and second terminals 26, 28 are suitable for communicating with one another remotely; to that end, they comprise complementary Bluetooth or Wi-Fi wireless communication means 30A, 30B.

The first terminal 26 comprises, aside from the wireless communication means 30A, a wireless communication system 32 to read data carried by the onboard item of equipment 12, a memory 33, a computer 34, a device 36 for presenting synthetic information to the operator, a battery 38 for powering communication means 30a, the communication system 32, the memory 33, the computer 34 and the presentation device 36, and a member 40, able to be actuated by the operator, for initiating the reading of data by the wireless communication system 32. It has no viewer.

The second terminal 28 comprises, aside from the wireless communication means 30B, a computer 42 to interpret the data read by the system 32, a viewer 44 to display the interpreted data, a memory 46 to store the interpreted data, a transmission module 48, via mobile telephone network, to transmit the interpreted data, and preferably, a battery 50 to power the computer 42, the viewer 44, the memory 46 and the transmission module 48. It has no wireless communication system to read the data carried by the onboard item of equipment 12.

The communication system 32 is typically a dedicated short-range communication (DSRC) system, the communication protocol for which is compliant with standards ISO 14906, EN 15509 and ISO 12813. This communication system 32 is compatible with the communication system 17 in the onboard item of equipment 12, such that the onboard item of equipment 12 and the terminal 26 can exchange data aerially.

The memory 33 of the first terminal 26 stores a list of identifiers of onboard items of equipment 12 signaled as not being in order.

The computer 42 of the second terminal 28 constitutes a main computer of the manual control device 20, and the computer 34 of the first terminal 26 constitutes a secondary computer of the manual control device 20.

The secondary computer 34 is programmed to read the information relative to the vehicle 14 carried by the onboard item of equipment 12, i.e., to look for this information in the memory 16 of the onboard item of equipment 12, via the communication systems 17, 32, and to return this first information onto the first terminal 26. It is also programmed to read other data carried by the onboard item of equipment 12, such as the identifier of the onboard item of equipment 12, or any malfunction signals emitted by the onboard item of equipment 12.

The secondary computer 34 is also programmed to preprocess the read data. This preprocessing comprises comparing the identifier of the onboard item of equipment 12 with the list of identifiers stored in the memory 33, and looking for a malfunction signal in the read data.

The presentation device 36 is suitable for presenting synthetic information to the operator of the control device 20 based on the result of the preprocessing of the read data. To that end, the presentation device is suitable for occupying three states each corresponding, bijectively, to one of the following cases:
first case: identification of the presence of the onboard item of equipment 12 in the list stored in the memory 33,
second case: identification of a malfunction signal of the onboard item of equipment 12 in the read data, and
third case: absence of identification of the presence of the onboard item of equipment 12 in the list stored in the memory 33 or a malfunction signal of the onboard item of equipment 12 in the read data,

and the secondary computer is programmed to command the change of state of the presentation device 36 in each of the three aforementioned cases, such that the presentation device 36 is in the state corresponding to the encountered case.

In particular, the presentation device 36 comprises two indicators 52, 54, and it is adapted so that the first 52 of said indicators 52, 54 has a blinking light in the first case and a steady light in the second case, the second indicator 54 having a steady light in the third case. Typically, the first indicator 52 is red and the second indicator 54 is green.

The control member 40 is for example a pushbutton. The secondary computer 34 is programmed to detect its actuation, and to trigger the reading of the onboard item of equipment 12 when the control number 40 is briefly actuated.

The secondary computer 34 is also programmed to download updates of its software in the list of identifiers stored in the memory 33 from a remote server (not shown), via the second terminal 28, the transmission module 48 to that end acting as a connection module to said remote server.

The secondary computer 34 is further programmed to transfer the read data to the second terminal 28, via the communication means 30A, 30B following a request from the operator consisting of a prolonged actuation of the control member 40.

Alternatively, the main computer 42 is programmed to command the transfer of the read data by the first terminal 26 to the second terminal 28 upon request by the operator communicated via the man-machine interface means. To that end, the main computer 42 is programmed to send a transfer request to the secondary computer 34, via communication means 30A, 30B, and the secondary computer 34 is programmed so as, after receiving the transfer request, to transfer the read data to the second terminal 28, via the communication means 30A, 30B.

The main computer 42 is also programmed to interpret the data read by the first terminal 26, i.e., to format that data such that it is readable by a human being, typically by converting bit values into text readable by the operator.

The main computer 42 is also programmed to command the display of data interpreted by the viewer 44, and to store the read data in the memory 46.

The main computer 42 is further programmed to transfer the read data to a remote server (not shown), via the transmission means 48, on request by the operator communicated by the man-machine interface means.

The man-machine interface means comprise the viewer 44, and optionally, pushbuttons. The viewer 44 is typically a touchscreen.

The onboard control device 22 comprises a terminal 56 onboard the vehicle 24, and the second terminal 28. The onboard terminal 56 is identical to the first terminal 26, with the only difference that the onboard terminal 56 is not a mobile terminal. The main computer 42 is programmed to perform the same operations on the data read by the onboard terminal 56 as those done on the data read by the first terminal 26.

Alternatively, the onboard terminal 56 has a wired connection with the second terminal 28.

A method 100 for controlling the onboard item of equipment 12 of a vehicle 14 using a manual control device 20 will now be described, in reference to FIG. 3.

The operator, equipped with the first terminal 26, first places himself at a sufficient distance from the vehicle 14 to allow the establishment of a communication between the communications systems 17, 32 of the first terminal 26 and the onboard item of equipment 12.

Once the operator is positioned at a suitable distance, he begins the control method 100 by briefly actuating the pushbutton 40.

The actuation 102 of the pushbutton 40 is detected by the secondary computer 34, which initiates remote reading 104 of the data of the onboard equipment 12 by the first terminal 26. During this reading step 104, the information relative to the vehicle 14, the identifier of the onboard item of equipment 12 and any malfunction signals of the onboard equipment 12 are recovered and transferred to the first terminal 26.

Then, during a preprocessing step 106, the secondary computer 34 preprocesses the read data. This preprocessing step 106 comprises a first sub-step 108 of looking for a malfunction signal, during which the secondary computer 34 looks for a malfunction signal in the read data, and a second sub-step 110 for comparing the identifier of the onboard item of equipment 12 with the list of identifiers stored in the memory 33.

Lastly, during a step 112, the secondary computer 34 commands the change of state of the presentation device 36 such that it occupies the state corresponding to the result of the preprocessing of the data. In other words, the secondary computer 34 commands the lighting of:
the first indicator 52 such that this indicator 52 remains steady, if it has identified a malfunction signal in the read data,
the first indicator 52 such that this indicator 52 blinks, if it has identified that the identifier of the onboard item of equipment 12 was present in the list stored in the memory 33, and
the second indicator 54 such that this indicator 54 remains steady, if no malfunction signal has been identified and the identifier of the onboard item of equipment 12 was missing from the list stored in the memory 33.

This step 112 is followed by a step 114 for waiting for a data transfer order. When no such order is sent by the operator, for example by prolonged actuation of the control member 40 or using man-machine interface means of the second terminal 28, the method 100 ends and the data is erased from the first terminal 26.

If, on the contrary, the operator commands the transfer of the read data, via the man-machine interface of the second terminal 28, this data is, during a step 116, transferred to the second terminal 28 aerially, from the first terminal 26 to the second terminal 28.

The transferred data is next interpreted, during a step 118, by the main computer 42.

The interpreted data is next displayed on the viewer 44, during a step 120, then the read data is stored in the memory 46, during a step 122.

Lastly, when the operator gives the order, the data stored in the memory 46 is transferred to a remote server, during a step 124.

Owing to the invention described above, the operator is only required to manipulate the first terminal 26. This first terminal 26 having no viewer, and the secondary computer only requiring a reduced computing power, it is possible to produce a light and compact terminal, which makes the manipulation particularly easy and reduces the risk of physical problems related to a prolonged use of the manual control device 20. The second terminal 28 can be left in the operators pocket, or even in the vehicle 24, which makes it possible to use a powerful main computer without hindering the manipulation of the manual control device 20.

Furthermore, the manual control device 20 is upgradable. It is in fact possible to give it new functions easily by replacing the second terminal 28 with a commercially available terminal on which an appropriate application has been installed beforehand. One may in particular use, as a replacement for the second terminal 28, the new smartphone from the operator, which will make it possible to achieve significant savings in the replacement cost of the second terminal. The first terminal 26, which constitutes the heart of the device and is the most expensive part, will not need to be replaced or even modified.

Furthermore, the operator may not have to consult the second terminal 28 owing to the synthetic information communicated to him by the first terminal. It is thus possible to inspect vehicles quickly.

Lastly, the second terminal 28 being shared by the manual and onboard control devices 20, 22, the operator of these devices 20, 22 has a single interface to consult the data collected following the inspections done both with the manual control device 20 and with the onboard control device 22. The operator therefore does not need to familiarize himself with several interfaces, and all of the data relative to the different inspections he has done is grouped together in the same place, which makes it easier to consult that data.

1. A control device for controlling the data carried by an onboard item of equipment, which is onboard a vehicle, of a fee collection system, the control device comprising a wireless communication system to read the data carried by the onboard item of equipment, a main computer to interpret the read data, and a viewer to display the interpreted data,
the control device comprising a first mobile terminal, suitable for being carried in an operator's hand, and a second terminal, said terminals being separate from one another and suitable for communicating with one another by wireless communication means, the first terminal incorporating the wireless communication system and the second terminal including the main computer and the viewer, the first terminal being suitable for transferring the read data to the second terminal via the wireless communication means,
wherein the first terminal comprises a secondary computer programmed to perform preprocessing of the read data and a device for presenting synthetic information to a user of the first terminal based on a result of the preprocessing of the read data the preprocessing of the read data comprising searching for a signal of a malfunction of the onboard equipment in the read data, and the presentation device being suitable for occupying a state corresponding to the identification, by the secondary computer, of a signal of a malfunction of the onboard equipment in the read data.

2. The control device according to claim 1, wherein the preprocessing of the read data comprises comparing an identifier of the onboard item of equipment with a list of identifiers stored in a memory of the first terminal, and the presentation device is suitable for occupying a state corresponding to the identification, by the secondary computer, of the presence of the identifier of the onboard item of equipment in the list.

3. The control device according to claim 2, wherein the presentation device is suitable for occupying a state corresponding to the lack of identification, by the secondary computer, of a signal of a malfunction of the onboard item of equipment in the read data or of the presence of the identifier of the onboard item of equipment in the list.

4. The control device according to claim 1, wherein the second terminal comprises a module for connecting to a remote server and the secondary computer is programmed to download updates from said remote server, via the second terminal, and to install said updates.

5. The control device according to claim 1, wherein the wireless communication system is a dedicated short-range communication system, and the wireless communication means comprise a Bluetooth or Wi-Fi communication system.

6. The control device according to claim 1, wherein the first terminal comprises a member, able to be actuated by a user, for initiating the reading of data by the wireless communication system.

7. A fee collection system comprising an onboard item of equipment onboard a vehicle and thee control device according to claim 1 to control the data carried by said onboard item of equipment.

8. The fee collection system according to claim 7, comprising an onboard terminal onboard on a vehicle, said onboard terminals including a wireless communication system to read the data carried by the onboard item of equipment, and means for communicating with the second terminal to transfer the read data to the second terminal, the main computer being programmed to interpret the data read by the onboard terminal, and the viewer being suitable for displaying this data after the data has been interpreted.

9. A method for controlling data carried by an onboard item of equipment, which is onboard a vehicle, of a fee collection system, wherein the method comprises the following steps:
remote reading, by a first mobile terminal able to be carried in an operator's hand, of data carried by the onboard item of equipment,
preprocessing, by the first terminal, of the read data,
presentation, by the first terminal, of synthetic information to a user of the first terminal based on a result of the preprocessing of the read data,
transfer of the read data aerially, from the first terminal to a second terminal,
interpretation of the transferred data by a computer of the second terminal, and
display of the interpreted data by a viewer of the second terminal,
the preprocessing step comprising a sub-step for looking for a malfunction signal of the onboard item of equipment in the read data.

10. The control method according to claim 9, wherein the preprocessing step also comprises a sub-step for comparing an identifier of the onboard item of equipment with a list of identifiers stored in a memory of the first terminal.

11. The control method according to claim 9, comprising a step for initiating the reading of the data by actuation of a member of the first terminal by a user.
